(19) United States
(12) Patent Application Publication
(10) Pub. No.: US 2012/0103465 A1
(43) Pub. Date: May 3, 2012

(54) LUBRICANT COLLECTING CONTAINER AND BEARING ARRANGEMENT WITH SUCH A LUBRICANT COLLECTING CONTAINER

(75) Inventors: Zdravko Paluncic, Ludwigshafen (DE); Andreas Schoenfeld, St. Leon-Rot (DE)

(73) Assignee: LINCOLN GMBH, Walldorf (DE)

(21) Appl. No.: 13/285,700

(22) Filed: Oct. 31, 2011

(30) Foreign Application Priority Data
Nov. 1, 2010 (DE) 202010014823.5

(51) Int. Cl. B67C 3/00; F16C 33/66

(52) U.S. Cl. 141/325; 184/5.1

(57) ABSTRACT

The invention pertains to a lubricant collecting container with a cartridge that features an inlet opening for introducing lubricant and a ventilation opening A sealing element is movably arranged in the cartridge and blocks a fluidic connection between the inlet opening and the ventilation opening in a sealed fashion.

### FIELD OF THE INVENTION

The invention pertains to a lubricant collecting container with a cartridge that features an inlet opening for introducing lubricant and a ventilation opening. The invention furthermore pertains to a bearing arrangement with such a collecting container.

### BACKGROUND OF THE INVENTION

In lubricating systems that supply different lubricating points such as, e.g., bearings with lubricant, excess or used lubricant is frequently accumulated and collected. For example, DE 20 2007 005 273 U1 discloses a bearing arrangement for a wind turbine that is equipped with a suction device for used grease being discharged from the bearing.

Plastic bottles that can be connected to the outlet of a bearing in a sealed fashion are frequently used for collecting the used lubricant. A ventilation bore is provided in such a plastic bottle in order to enable the air situated in the bottle to escape outward while the bottle is filled, e.g., with used grease from a bearing. In practical applications, however, it proved disadvantageous that grease or similar lubricants can also escape through the ventilation bore. Consequently, it cannot be ensured that the used grease being discharged from a bearing is collected in its entirety. In addition, such plastic bottles are usually discarded after their use because a significant effort is involved with the removal of the used grease from the bottles.

EP 2 093 474 A2 describes a particularly lightweight container for collecting lubricant that is realized in the form of a cardboard box, the interior of which is lined with a film. This container is used similar to the above-described plastic bottles.

The present invention, in contrast, is based on the objective of making available an improved lubricant collecting container that is suitable, in particular, for use in large-size bearings.

### SUMMARY OF THE INVENTION

According to the invention, this objective is essentially attained with a lubricant collecting container with the characteristics of claim 1. In the inventive collecting container, a sealing element that blocks a fluidic connection between the inlet opening and the ventilation opening in a sealed fashion may be provided in the cartridge. In other words, the sealing element prevents, e.g., used grease or other used lubricant that reaches the cartridge through the inlet opening from escaping through the ventilation opening. In order to still realize pressure compensation between the interior of the cartridge and its surroundings, the sealing element is, according to the invention, movably arranged within the cartridge. Used lubricant therefore can be introduced into the cartridge with the least back pressure possible and without risking that the lubricant can escape from the cartridge through the ventilation opening.

According to a preferred embodiment of the invention, the cartridge may be realized similar to a bottle, e.g., with an about cylindrical base body, a tapered neck region with the inlet opening arranged therein and, if applicable, a bottom, in which the ventilation opening may be provided. Alternatively, it would also be possible to completely eliminate the bottom of the cartridge such that the open end of the cartridge forms the ventilation opening. The cartridge preferably consists of a rigid and dimensionally stable material such as, e.g., plastic that is suitable for supporting the weight of the filled cartridge.

According to a first embodiment of the invention, the sealing element consists of a piston, particularly a follower piston, that is accommodated within the cartridge in a displaceable fashion. In the initial position, i.e., when the cartridge is empty, the piston is situated within the cartridge on the side of the inlet opening. As the cartridge is filled, the piston is displaced away from the inlet opening by the lubricant that enters the cartridge through the inlet opening. The lubricant pressure required for filling the cartridge is very low because air situated in the cartridge can escape through the ventilation opening arranged on the side of the piston opposite the lubricant.

According to an additional development of this inventive embodiment, it is proposed that the piston is arranged within the cartridge in such a way that it can be displaced within the cartridge due to a pressure differential between the inlet opening and the ventilation opening of less than about 1 bar. According to the invention, the pressure of the used lubricant required for moving the piston is as low as possible so as to prevent an undesirable pressure increase within the bearing or similar device of a lubricating system. The pressure differential preferably amounts to less than about 0.75 bar and lies, e.g., between about 0.2 bar and about 0.5 bar.

According to another embodiment of the invention, the sealing element is realized in the form of a plastically and/or elastically deformable membrane. This membrane preferably is fixed within the cartridge in such a way that lubricant cannot reach the ventilation opening from the inlet opening. In this case, the inventive mobility of the membrane within the cartridge may be realized in the form of an elastic deformation of the membrane due to the introduced lubricant and/or preferably in the form of a plastic deformation of the membrane. However, the membrane also may be sectionally fixed within the cartridge and still be movable. In this case, only a section such as, e.g., a free end of the sealing element is movably arranged within the cartridge.

In this case, the surface area of the membrane that respectively faces the inlet opening or the used lubricant is preferably larger than a cross-sectional area of the cartridge in a section of the cartridge that lies between the inlet opening and the ventilation opening. This makes it possible, e.g., to realize the membrane in the form of a bag that is fixed in the cartridge in a sealed fashion. In the empty state of the cartridge, this bag may be curved or protrude in the direction of the inlet opening and then moved or deformed in the direction of the ventilation opening or an open end of the cartridge by the lubricant entering the cartridge.

With respect to the membrane, it is also preferred to maintain the pressure differential between the inlet opening and the ventilation opening required for moving the membrane within the cartridge as low as possible, particularly lower than about 0.5 bar, preferably lower than about 0.25 bar.

In both inventive embodiments, the collecting container can also be emptied with little effort, particularly if a piston is used as sealing element. In contrast to conventional solutions, the inventive collecting container therefore can be reused. In addition, it is easier to transfer the used grease or other used lubricant to a facility for the reuse or further use thereof.

According to another aspect of the invention, the inlet opening of the cartridge is provided with an adapter for being detachably connected to a lubricant outlet. Consequently, the collecting container can be connected to a bearing outlet or the like with little effort by means of the adapter and, if applicable, an angled or straight screw coupling. This also simplifies the exchange of the collecting container.

The invention furthermore pertains to a bearing arrangement with a rolling bearing or a sliding bearing and a lubricating system connected to this bearing. The lubricating system is provided with a device for feeding lubricant into the bearing, as well as a lubricant outlet for discharging lubricant from the bearing. According to the invention, the lubricant outlet is connected to a collecting container of the above-described type in order to collect lubricant being discharged from the bearing in the collecting container.

The bearing preferably consists of a large-size bearing, e.g., of the type used in wind turbines. Bearings of this type consist of an outer ring, and inner ring and rolling bodies arranged in between, wherein elements of the lubricating system for supplying lubricant and for discharging or removing lubricant by suction may be integrated into the inner race and/or into the outer race.

Exemplary embodiments of the invention are described in greater detail below with reference to the drawings.

### BRIEF DESCRIPTION OF THE DRAWINGS

In these schematic drawings:

FIG. 1 shows a collecting container according to a first embodiment of the invention in the empty state,

FIG. 2 shows the collecting container of FIG. 1 in the partially filled state,

FIG. 3 shows a collecting container according to another embodiment of the invention in the empty state, and

FIG. 4 shows the collecting container of FIG. 3 in the partially filled state.

### DETAILED DESCRIPTION

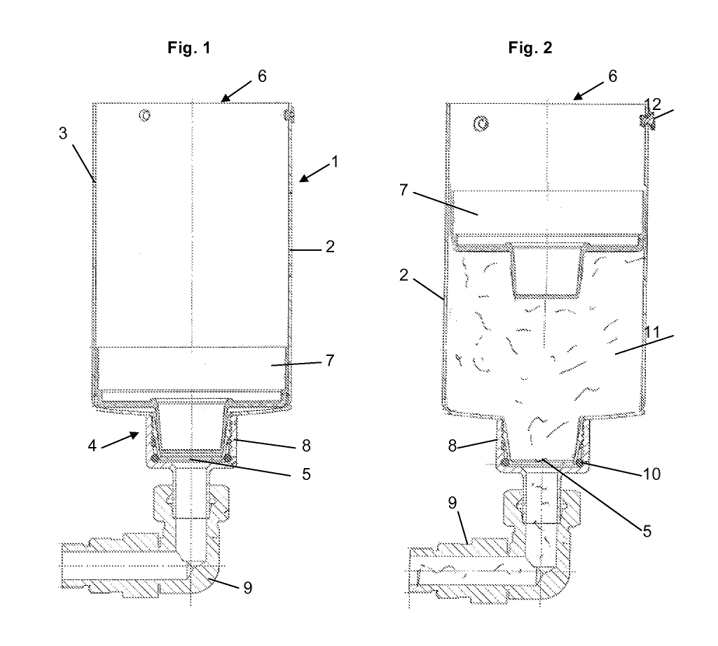

The collecting container 1 illustrated in the figures essentially consists of a bottle-like cartridge 2 and a sealing element accommodated therein. The cartridge 2 has a cylindrical base body 3 and, e.g., a neck 4 that is tapered relative to the base body 3 and contains an inlet opening 5. In the embodiment illustrated in FIGS. 1 and 2, the opposite end of the base body 3 referred to the inlet opening 5 is not closed and therefore forms a ventilation opening 6.

In the embodiment illustrated in FIGS. 1 and 2, the sealing element is realized in the form of a (follower) piston 7 that is accommodated within the cartridge 2 in a displaceable fashion. The illustration according to FIG. 2 also shows that the piston 7 features a region that is guided on the inner wall of the base body 3 in a sealed fashion, as well as a region that faces the inlet opening 5 and is at least approximately adapted to the contour of the tapered neck 4. This means that almost no dead volume remains within the cartridge 2 in the position of the piston 7 illustrated in FIG. 1, in which the cartridge 2 is empty.

The inlet opening 5 is connected to a lubricant outlet 9 of a not-shown lubricating system in a sealed fashion by means of an adapter 8. In the embodiment illustrated in FIG. 1, the lubricant outlet 9 is realized in the form of an angled screw coupling. Alternatively, it would also be possible to use lubricant outlets with different designs such as, e.g., a lubricant outlet in the form of a straight screw coupling. A sealing ring 10 may be provided in the adapter 8 in order to seal the cartridge 2 within the adapter 8.

When the collecting container 1 is connected to a bearing arrangement or the like, e.g., as part of a lubricating system, excess or used lubricant flows into the inlet opening 5 of the cartridge 2 through the lubricant outlet 9 during the operation of the system.

The piston 7 is displaced upward in FIG. 1 by the lubricant entering the cartridge 2. FIG. 2 shows the cartridge 2 in a state, in which it is partially filled with lubricant 11 and the piston 7 has been displaced from the position illustrated in FIG. 1.

Since only the frictional forces of the piston 7 within the cartridge 2 need to be overcome in order to fill the cartridge 2, it is also possible to fill the cartridge 2 at a very low pressure of the lubricant 11, e.g., between about 0.2 and about 0.3 bar. The piston 7 can be prevented from falling out of the cartridge 2 by means of a stopper 12 that is arranged within the base body 3 in the vicinity of the ventilation opening 6.

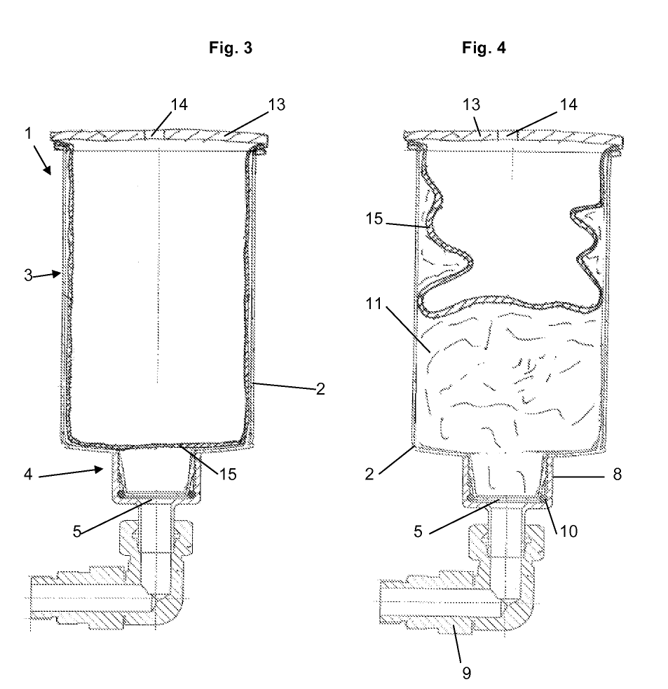

A second embodiment of the invention is illustrated in FIGS. 3 and 4. In this case, the design of the cartridge 2 essentially corresponds to the design described above with reference to FIGS. 1 and 2.

However, the side of the cartridge 2 that faces away from the inlet opening 5 is closed with a bottom 13, in which a ventilation opening 14 is arranged. Furthermore, a membrane 15 that is realized in the form of a plastic bag in the embodiment shown is provided in the cartridge 2 instead of the piston 7. In this case, the surface area of the membrane 15 that faces the inlet opening 5 or the lubricant entering through this inlet opening is significantly larger than the cross section of the base body 3 of the cartridge 2.

In contrast to the illustration according to FIG. 3, the membrane 15 may also extend as far as the neck region 4 in the vicinity of the inlet opening 5 in the empty state of the cartridge. The membrane 15 preferably consists of a material that is impervious to lubricant, but can be easily deformed within the cartridge 2. In this way, the lubricant 11 entering the cartridge 2 can move the membrane 15 within the cartridge, i.e., compress the plastic bag within the cartridge 2, without noteworthy back pressure. During this process, any air situated between the membrane 15 and the bottom 13 can escape from the cartridge 2 through the ventilation opening 14.

It is preferred to rigidly connect the membrane 15 to the cartridge 2. This may be realized, e.g., by welding the membrane 15 to the edge region of the base body 3 on the ventilation side. Alternatively, it is also possible to clamp the membrane 15 within the cartridge 2 in a sealed fashion, e.g., by means of the bottom 13. The membrane 15 may also be fixed within the cartridge in other positions as long as a fluidic connection between the inlet opening 5 and the ventilation opening 14 is hereby prevented.

List of Reference Symbols
1 Collecting container
2 Cartridge
3 Base body
4 Neck
5 Inlet opening
6 Ventilation opening
7 Piston
8 Adapter
9 Lubricant outlet
10 Sealing ring
11 Lubricant
12 Stopper
13 Bottom
14 Ventilation opening
15 Membrane (plastic bag)

1. A lubricant collecting container with a cartridge that features comprises an inlet opening for introducing lubricant and a ventilation opening, characterized by the fact that a sealing element is movably arranged in the cartridge and blocks a fluidic connection between the inlet opening and the ventilation opening in a sealed fashion.

2. The collecting container according to claim 1, characterized by the fact that the cartridge comprises a cylindrical base body, and a tapered neck region with the inlet opening arranged therein.

3. The collecting container according to claim 1, characterized by the fact that the sealing element consists of a piston that can be displaced within the cartridge.

4. The collecting container according to claim 3, characterized by the fact that the piston is arranged within the cartridge in such a way that the piston can be displaced within the cartridge due to a pressure differential between the inlet opening and the ventilation opening of less than 1 bar.

5. The collecting container according to claim 1, characterized by the fact that the sealing element consists of a plastically and/or elastically deformable membrane.

6. The collecting container according to claim 5, characterized by the fact that the surface area of the membrane that faces the inlet opening is larger than the cross-sectional area of the cartridge in a section of the cartridge that lies between the inlet opening and the ventilation opening.

7. The collecting container according to claim 5, characterized by the fact that the membrane is realized in the form of a bag that is fixed in the cartridge in a sealed fashion.

8. The collecting container according to claim 5, characterized by the fact that the membrane can be moved within the cartridge due to a pressure differential between the inlet opening and the ventilation opening of less than 0.5 bar.

9. The collecting container according to claim 1, characterized by the fact that the inlet opening of the cartridge is provided with an adapter for being detachably connected to a lubricant outlet.

10. A bearing arrangement with a rolling bearing and a lubricating system connected thereto, wherein the lubricating system comprises a device for supplying lubricant into the rolling bearing and a lubricant outlet for discharging lubricant from the rolling bearing, and wherein the lubricant outlet is connected to a collecting container according to claim 1.

11. The collecting container according to claim 2, wherein the cartridge further comprises a bottom in which the ventilation opening is provided.

12. The collecting container according to claim 11, characterized by the fact that the sealing element consists of a piston that can be displaced within the cartridge.

13. The collecting container according to claim 12, characterized by the fact that the piston is arranged within the cartridge in such a way that the piston can be displaced within the cartridge due to a pressure differential between the inlet opening and the ventilation opening of less than 1 bar.

14. The collecting container according to claim 13, wherein said pressure differential is less than 0.5 bar.

15. The collecting container according to claim 11, characterized by the fact that the sealing element consists of a plastically and/or elastically deformable membrane.

16. The collecting container according to claim 15, characterized by the fact that the surface area of the membrane that faces the inlet opening is larger than the cross-sectional area of the cartridge in a section of the cartridge that lies between the inlet opening and the ventilation opening.

17. The collecting container according to claim 15, characterized by the fact that the membrane is realized in the form of a bag that is fixed in the cartridge in a sealed fashion.
